(19) United States
(12) Patent Application Publication
(10) Pub. No.: US 2008/0024061 A1
(43) Pub. Date: Jan. 31, 2008

(54) Incandescent lamp having a carbide containing luminous element

(75) Inventors: Axel Bunk, Munchen (DE); Matthias Damm, Gaimersheim (DE); Frank Friess, Otterstadt (DE); Adalbert Kovacs, Dossenheim (DE); Georg Rosenbauer, Wassertrudingen (DE); Georg Schwarz, Dossenheim (DE); Gerhard K. Wolf, Heidelberg (DE); Christa Bunk, Munchen (DE)

Correspondence Address: OSRAM SYLVANIA INC, 100 ENDICOTT STREET, DANVERS, MA, 01923, US

(73) Assignees: PATENT-TREUHAND-GESELLSCHAFT FUR ELEKTRISCHE GLUHLAMPEN MBH, MUNCHEN (DE); IP2H AG, BERN (SZ)

(21) Appl. No.: 11/878,834

(22) Filed: Jul. 27, 2007

(30) Foreign Application Priority Data
Jul. 28, 2006 (DE) 10 2006 035 792.2

(51) Int. Cl. H01K 1/04; H01J 9/02; H01K 1/20

(52) U.S. Cl. 313/578; 445/27

(57) ABSTRACT

An incandescent lamp having a carbide containing luminous element, uses a wire for the luminous element that is coated on the outside with at least two different high melting metal compounds from at least one of the groups of carbides, borides and nitrides. The luminous element reaches a temperature of at least 3000° K during operation.

### TECHNICAL FIELD

The invention proceeds from an incandescent lamp having a carbide containing luminous element in accordance with the preamble of claim 1. Such incandescent lamps are used for general lighting and for photooptical purposes.

### BACKGROUND ART

A known option for raising the efficiency of incandescent lamps is to use incandescent elements made from high melting ceramics such as tantalum carbide. The raising of the efficiency results from the fact that the incandescent element made from metal carbide can be operated at a higher temperature because of having a much higher melting point by comparison with the pure metals: the melting point for TaC is 3880° C. as against 3410° C. for tungsten. In addition, by comparison with tungsten the emission coefficient of the carbides in the visible range is greater than in the infra-red. Tantalum carbide, in particular, is a better “selective emitter” than tungsten.

One problem in operating tantalum carbide luminous elements at high temperatures is the decarburization; the latter leads to the formation of subcarbides of higher resistivity and lower melting point, and thus to the rapid destruction of the luminous element. It is particularly problematic in this case that the carbon vapor pressure over tantalum carbide is relatively high. At the same operating temperature, the vaporization rate of carbon over tantalum carbide is greater by more than an order of magnitude than that of tungsten over a tungsten surface. Moreover, if no suitable countermeasures are taken, the strong carbon vaporization leads to a rapid bulb blackening, which prevents light from exiting through the glass bulb. A number of approaches to solving or warding off this problem are to be found in the literature.

One possibility is the addition of carbon and hydrogen to the fill gas, see, for example, U.S. Pat. No. 2,596,469. A cyclic carbon process is produced in the lamp in this case. The carbon evaporated at high temperatures reacts at lower temperatures with hydrogen to form hydrocarbons that, by convection and/or diffusion, are transported back to the filament where they are decomposed again. The carbon produced in the process is partially taken up again onto the filament. A functioning cyclic carbon process mostly requires the use of a hydrogen surplus in order to avoid the deposition of carbon (in the form of carbon black) in the lamp vessel. For example, when use is made of methane or ethane the partial pressure of the hydrogen must be greater by approximately a factor of 2 than that of the hydrocarbon. Otherwise, carbon comes to be deposited in the lamp vessel. Since the requisite concentrations of carbon and hydrogen mostly have to lie in the region of up to a few percent, the high fraction of hydrogen has a negative effect on the efficiency of the lamp.

In order to reduce the loss of efficiency, halogens have also been used in addition to hydrogen for the purpose of reaction with the carbon, see U.S. Pat. No. 3,022,438, for example. The carbon evaporating from the luminous element reacts in the cold regions near the bulb wall with, for example, chlorine atoms to form compounds such as CCl₄, the result being to avoid a deposition of the carbon on the wall. The carbon-halogen compounds are transported back in the direction of the incandescent element by transport processes such as convection and diffusion, decomposing in the process in the warmer region with the release of the carbon. The carbon can be taken up again on the filament. In order to prevent the carbon from being deposited using the halogen and hydrogen, it is necessary in accordance with U.S. Pat. No. 3,022,438 for both the quantity of the halogen atoms introduced overall into the lamp, and the quantity of the element hydrogen to be greater in each case than the quantity of carbon present overall in the gas phase. Since the carbon-chlorine and carbon-bromine compounds can be formed mostly only at temperatures that are around or below approximately 150° C., the application of the cyclic carbon-halogen process is limited to lamps with a relatively large bulb volume and thus bulb temperatures that are around or below 200° C.

It is disadvantageous of the cyclic processes mentioned that both carbon-hydrogen compounds and carbon-chlorine or carbon-bromine compounds may decompose at temperatures below 1000° C. Consequently, the carbon is already deposited to a large part on the supply leads to the filament, and is withdrawn from the further reaction events. In no case is there a preferred feedback of the carbon to the hottest site on the luminous element (so called regenerative cyclic process), from where, after all, the vaporization of carbon preferably takes place. Consequently, the benefit using hydrogen and/or halogens resides firstly in the avoidance of bulb blackening. The benefit with regard to the lengthening of service life is only slight.

There are a number of possibilities of lengthening the service life even in the absence of a regenerative cyclic process.

One option for lengthening the service life consists in the regeneration of the luminous element from a depot such as is described in U.S. Pat. No. 7,026,760. In this case, the carbon evaporated from the luminous element is, compensated for by feeding carbon from a depot.

A further possibility, described in WO2006045273, of preventing the rapid decarburization of a tantalum carbide luminous element consists in operating the latter in an atmosphere which is enriched from outside with carbon so strongly that a carbon depletion of the luminous element is avoided. The luminous element is preferably operated in an atmosphere in which the carbon vapor pressure corresponds approximately to the equilibrium vapor pressure of carbon over tantalum carbide. This is achieved by transporting carbon permanently from a source into a sink.

For lamps having a supply lead produced as an integral part of the luminous element, DE-A 102004034876 and WO2006007816 disclose a coating of parts of the integral supply lead of a carbide containing luminous element with carbides, borides or nitrides. The coatings are in this case exposed to temperatures of at most 2500 K. The aim here is to prevent carbon from diffusing into the supply lead during the carburization process.

GB 2 032 173 discloses providing luminous elements made from metals or metal alloys or carbon with coatings that suppress vaporization and the bulb blackening resulting therefrom. The main field of application is vacuum lamps or at least lamps without any cyclic processes and, consequently, a relatively low luminous element temperature of typically 2700 K. By contrast, virtually every substance has a noticeable vapor pressure at a high luminous element temperature of at least 3000 K. Here, bulb blackening is prevented via cyclic processes.

The coating of metals with metal carbides can also advantageously be applied in order to circumvent the problems partially occurring with respect to the absence of shock resistance in metal carbide luminous bodies. For example, the use of rhenium wires is described in U.S. Pat. No. 1,854,970. Rhenium does not form carbides and dissolves carbon only to a certain extent, and so does not decarburize metal carbides, by contrast with most other metals. With this in mind, it is possible to coat rhenium wires with TaC; moreover, the advantageous properties of metal carbides can thus be applied in conjunction with satisfactory shock resistance. It is possible to proceed in a similar way with other materials that do not form carbides, such as osmium, for example. Furthermore, materials that form carbides can be coated with materials forming no carbides, in order to achieve a satisfactory shock resistance, at least beyond the burning time of the lamp. Over lengthy burning times, diffusive mixing of the substrate forming the carbides with the other metal forming no carbides comes about.

### DISCLOSURE OF THE INVENTION

The object of the present invention is to lengthen the service life in the case of a luminous element of the generic type, and to specify a method of producing it.

This object is achieved by means of the characterizing features of claim 1. Particularly advantageous refinements are to be found in the dependent claims.

The invention is based on the idea of undertaking changes in the basic material (substrate) of the luminous element such that alloying produces on the highly loaded luminous element with an operating temperature of at least 3000 K a layer that raises the melting point and lowers the vapor pressure. In the case of lamps with cyclic processes, this measure acts in the direction of a further lengthening of the service life. Should alloying occur in operation owing to diffusion processes over the entire cross section of the luminous element, a stabilization of the grain boundaries is often obtained as a positive side effect. In addition, it is possible in part to influence the emissivity of the surface positively in the visible spectral region, and to improve the shock resistance.

The invention utilizes the fact, known per se, that the alloys of various carbides, for example those made from HfC and TaC as well as from ZrC and TaC have a higher melting point than the individual components. In the TaC—HfC system, for example, the melting points of TaC and HfC are at 4150 K and 4160 K; respectively; the melting point maximum that is found for the composition of 80% TaC+20% HfC is 4215 K, compare Agte and Alterthum, Zeitschrift für technische Physik, No. 6 (1930). Similarly, in accordance with Agte and Alterthum the melting point maximum in the TaC/ZrC system is found at 80% TaC+20% ZrC. For this composition, the melting temperature is 4205 K, while the melting points of the pure components lie at 3805 K (ZrC) and 4150 K (TaC). A metallurgical production of wires or else of luminous elements of another shape from said alloys is complicated. Because of the formation of mixed crystals, these wires are embrittled, and so wire drawing is extremely difficult. The invention is based on the idea of proceeding from wires composed of only one metal carbide component for the luminous element, and of applying further high melting components by means of coating processes that convey a lowering of vapor pressure when combined.

The simultaneous use of two coating components in a mixture achieves an immediate lowering of vapor pressure. A similarly rapidly acting lowering of vapor pressure is attained by the use, easier to handle in part, in terms of production engineering, of two coating components in thin layers that lie one above another, diffuse into one another in operation of the lamp, and thereby form a mixture.

One coating component can, in principle, be identical to the substrate. With such an arrangement, it is fundamentally possible to apply only one coating component made from another material such that the vapor pressure is lowered near the surface after diffusive mixing of the substrate with the coating component. However, this effect occurs in operation only after a certain time, while coating with two components acts virtually without a run-up phase.

In this case, it is even possible in the long term, after several operating hours for there to be alloying in the entire carrier material through diffusive mixing. Alternatively, the formation of an alloy is concentrated on the surface of the luminous element. At least a few components can also be enriched on the surface. The mode of procedure is to be explained with the aid of a few examples.

(a) As first example, consideration may first be given to a luminous element made from tantalum, for example a tantalum filament wound from round wire. In the first embodiment, other metals, such as hafnium, niobium and zirconium are applied in any desired coating method (for example sputtering, CVD deposition, electrolytic deposition, etc) to the surface of the tantalum wire. The metal applied by coating is caused to diffuse into the interior of the luminous wire consisting of tantalum by interposed heating to temperatures typically in the range of between approximately 2000 K and 2800 K. The application is typically carried out by coating and subsequently homogenizing by diffusion in a number of stages. Consequently a largely homogeneous distribution of the applied metal is obtained in the tantalum. There is then formed in the subsequent carburization a mixed carbide that, with the selection of suitable metals and/or alloy ratios, has a higher melting point and a lower vapor pressure than the starting material. At least a partial stabilization of the grain boundaries comes about owing to the addition of the second metal.

(b) Of course, it is also possible to proceed from other metals as basic material than from tantalum. For example, a wire made from zirconium can be coated with hafnium or niobium, and the hafnium or niobium can subsequently be distributed homogeneously in the wire by diffusion. The alloy is preferably formed again in a number of stages, that is to say a thin layer of the material to be coated is firstly applied, then the material of the layer is distributed as uniformly as possible in the material of the basic wire (here zirconium) by diffusion, typically at temperatures above 2000 K. Were a material differing largely in expansion coefficient to be applied in an excessively large layer thickness to the (for example wire-shaped) basic material, there is a risk of the latter peeling off in the event of temperature changes, because layer stressing can occur owing to the various coefficients of thermal expansion. In the nature of things, the metal applied by coating is always the one that is present in deficit for the alloy composition with the melting point maximum.

(c) It is also possible to dispense with a complete homogenization of the metals before the carburization in the two preceding examples (a) and (b). A further-reaching homogenizing is then performed during the carburization and/or partially, also during lamp operation.

(d) If required, instead of only one metal it is also possible to apply a number of metals simultaneously or one after another by coating, and to diffuse them into the basic metal by heating to suitable temperatures.

(e) An attempt is made in a further embodiment to enrich the alloy in the outer region of the wire. As described, inter alia, in V. Valvoda, L. Dobiasova, P. Karen, “X-ray diffraction analysis of diffusional alloying of HfC and TaC”, Journal of Materials Science 20, 3605-3609 (1985), a certain time is required for the diffusive mixing of the various carbides; and even when the materials are finely pulverized and pressed together, complete mixing is not found, at least at temperatures around 2000° C. Thus, for example, the procedure here is as follows. There is applied to a starting wire of a carbide forming metal a thin layer of a second carbide forming metal. This is followed by carburization in a hydrocarbon containing atmosphere, preferably at temperatures below 2500° C. At these temperatures, the diffusion of the carbon, and thus the carburization takes place much more rapidly than the diffusion of the two metals. An enrichment of the carbide of the metal applied by coating is therefore obtained on the surface. When the lamp is operated at relatively high temperatures, at least partial mixing of the carbides then takes place through diffusion; in this case, the high melting alloy made from two carbides is formed on the surface. For example, if a luminous element made from TaC has been coated with HfC, as the operating time of the lamp advances a mixture with TaC, and thus a raising of the melting point and lowering of the vapor pressure come about near the surface—where there has formerly been pure HfC. However, a complete mixing of the two carbides requires a certain time, and the mixing is also not complete. Complete mixing of the two carbides is mostly undesired, because in this case the concentration of the carbide present in deficit on the surface drops to values so low that the effects of raising the melting point and lowering vapor pressure are only relatively slight—unless so much of the second metal was applied that there is still present at the surface a relatively high enrichment of the carbide present in deficit even after far reaching mixing. In order to prevent the applied metal or the metal carbide layer forming on the surface from peeling off, it is expedient here, as well, to permit the metal applied by coating to diffuse at least partially into the basic wire. The result of this is a gradient of the material applied by coating from outside the wire in the direction of the interior of the wire, and this reduces the tendency to peel off, particularly after carburization.

Instead of depositing only one second metal on the first metal, it is also possible to deposit two metals simultaneously on the first metal. For example, a mixture made from tantalum and hafnium in the desired molecular ratio of 80% to 20% can be deposited, and carburization can be undertaken subsequently. Carburization yields a TaC wire with an alloy of 80% TaC+20% HfC on the outside of the wire, which melts higher than pure TaC. In this case, there is immediate depletion of HfC on the outside of the luminous element in the case of the diffusive mixing during operation of the lamp, and there is consequently a lowering of the melting point and a raising of the vapor pressure.

(f) An alternative to the last named example (e), instead of a metal it is also possible at once to deposit a second metal carbide on a first metal carbide. For example, an incandescent element made from tantalum can firstly be carburized, and then the second metal carbide, for example hafnium carbide, can be deposited on the tantalum carbide. As described above, diffusion leads again to enrichment of the high melting alloy on the surface.

Instead of this, it is also possible to deposit a mixture of carbides on the luminous element of the starting carbide. For example, a mixture made from tantalum carbide and zirconium carbide in the ratio 80:20 can be deposited on the luminous element made from tantalum carbide. Consequently, an alloy melting at higher temperatures than pure TaC is located on the outside of the wire.

(g) Of course, mixed forms between e) and f) are possible with regard to the method of production. For example, a wire made from a metal can be formed by carburization into a metal carbide, and then a further metal or a mixture of various further metals can be deposited on this metal carbide, and only then subsequently carburized. It is also possible for a carbide layer to be deposited on the pure metal. For example, a carbide layer can be applied by flushing, since carbide powder can be very finely pulverized. During the carburization process, the carbon diffuses through the carbide layer and converts the metal into a carbide.

(h) In a further preferred embodiment, the material that is present in deficit in the higher melting alloy is deposited on a basic material that is, in general (but not necessarily), the material present in surplus in the high melting alloy. Thereupon, the material present in surplus in the alloy is deposited on the luminous element. For example, hafnium can be deposited on a tantalum wire, and a tantalum layer can again be laid over this hafnium layer. These metals can now initially be mixed in a partially diffusive fashion and only then be carburized, or carburization can firstly be performed and only then can the carbides be diffusively mixed. After the carburization and at least partial diffusive mixing, an enrichment of the higher melting alloy made from tantalum carbide and hafnium carbide is obtained on the surface. Instead of depositing the metals and only then carburizing them, it is also possible again to deposit the carbides at once.

(1) It is essentially metal carbides that have previously been mentioned in the exemplary embodiments. Even if carbides are the most interesting with regard to practical applications, the principles described here can also be transferred to metal nitrides and metal borides and/or alloys of metal carbides, metal borides and metal nitrides.

The coating is preferably undertaken by means of established CVD or PVD processes. However, it is also possible to use electrolytic deposition processes, wet chemical methods or flushing processes.

Established reactions of the type MeCl₅+CH₄+½ H₂->MeC+5 HCl (Me=Ta, Hf) are available for CVD deposition. It is also possible to use other halides instead of chlorides.

The use of CVD methods provides the option of carrying out the deposition in a temperature range such that the deposition rates vary over the temperature range of the luminous element. By way of example, consideration is given to an incandescent filament of constant pitch and wire thickness, in the case of which the highest temperatures are found in the regions near the middle. More material than in the colder regions near the filament ends is then deposited in the region near the middle using a CVD process. The result of this is that the temperature profile along the filament is homogenized, something which favorably affects the service life. However, it must be emphasized that here the layer thickness applied should be oriented primarily to an optimization with regard to a sufficient service life of the layer in conjunction with keeping the desired composition, and less to a smoothing of the temperature profiles over the filament. Finally, the quality of the lamp must be optimized experimentally. The use of PVD methods and/or wet chemical or flushing methods generally yields homogeneous layer thicknesses over the luminous element. Typical layer thicknesses are in the range from 1 μm-40 μm.

### BRIEF DESCRIPTION OF THE DRAWINGS

The invention is to be explained in more detail below with the aid of a number of exemplary embodiments. In the figures:

FIG. 1 shows an incandescent lamp having a carbide luminous element in accordance with one exemplary embodiment;

FIG. 2 shows a first exemplary embodiment of a luminous element for the incandescent lamp in accordance with FIG. 1, in section; and

FIG. 3 shows a second exemplary embodiment of a luminous element for the incandescent lamp in accordance with FIG. 1, in section.

### BEST MODE FOR CARRYING OUT THE INVENTION

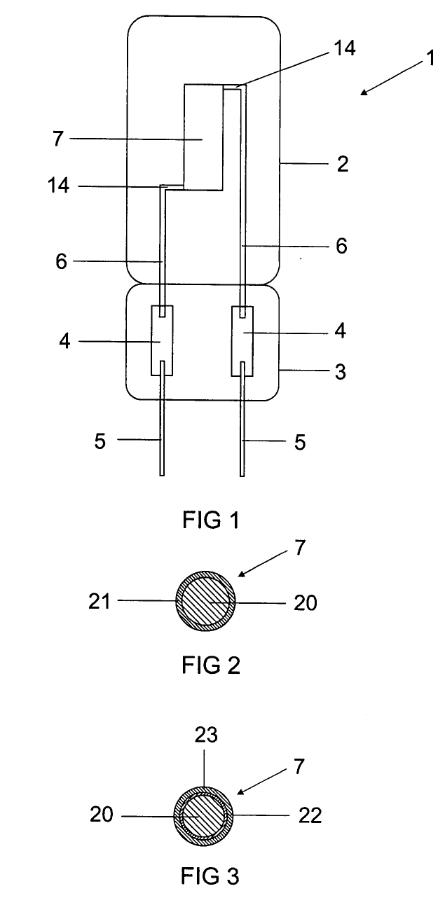

FIG. 1 shows an incandescent lamp 1, pinched at one end, having a bulb made from silica glass 2, a pinch 3, and internal supply leads 6 that connect foils 4 in the pinch 3 to a luminous element 7. The luminous element is a singly helically wound, axially arranged wire made from TaC as carrier material, whose non helically wound ends 14 are continued transverse to the lamp axis. External supply conductors 5 are attached outside to the foils 4. The inside diameter of the bulb is 5 mm. The supply leads 6 are either separate parts made from Mo, W or Ta, or they are continued integrally as non helically wound ends of the luminous element. The temperature in the region of the supply leads is typically at most 2300 K. The temperature of the helically wound luminous element 7 is at least 3000 K.

The incandescent filament, consisting of tantalum carbide, of the lamp shown schematically in FIG. 1 and whose fundamental design corresponds largely to a low voltage halogen incandescent lamp available on the market, is being produced by carburizing a helically wound filament (6 turns) made from tantalum wire (diameter 125 μm). When use is made as carrier gas of xenon to which there are further added hydrogen, nitrogen, hydrocarbon and halogen (J, Br, Cl, F) containing substances, the lamp has a power consumption of approximately 40 W during operation at 13 V, the colour temperature being characteristically around 3500 K.

The luminous element 7 is provided with a coating that consists of a 5 to 12 μm thick layer made from a mixture of TaC and HfC with an amount of substance ration of 80:20 (molecular composition).

The luminous element 7 is demonstrated schematically in more detail in FIG. 2. It has in cross section a carrier material 20 made from TaC that forms the core. The typical diameter is 50 to 200 μm. Applied thereto is a layer 21 that consists of a mixture of TaC/HfC, as explained above.

A further exemplary embodiment of a luminous element 7 is illustrated in more detail schematically in FIG. 3. In cross section it has a carrier material 20 made from TaC that forms the core. The typical diameter is 80 to 120 μm. Applied thereto is a first layer 22 that consists of ZrC or HfC, or a mixture thereof and is approximately 15 μm thick. Applied thereto is a second layer 23 made from TaC whose thickness is approximately 10 μm.

The boundaries of the layers may become faded in the course of the service life in an increasing fashion as a consequence of diffusive mixing. After a possible burning operation (typical duration of a few minutes), the layer structure is, however, still plainly detectable in the case of a lamp offered for sale. It is only after a few hours of burning life that the layer structure is increasingly transformed into a gradient structure.

1. An incandescent lamp having a luminous element made from a metal carbide as carrier material, and a coating applied thereon, the luminous element being accommodated in a bulb, the bulb containing a filling that enables chemical transport processes, wherein the luminous element reaches at least a temperature of 3000 K during operation, the carrier material being coated with at least two different materials that are selected from the group of the metal carbides, metal nitrides or metal borides.

2. The incandescent lamp as claimed in claim 1, wherein the various materials of the coating are applied one after another.

3. The incandescent lamp as claimed in claim 1, wherein the various materials of the coating are applied in a fashion mixed with one another, in particular as alloy.

4. The incandescent lamp as claimed in claim 1, wherein the layer consists of two materials, in particular of two carbides.

5. The incandescent lamp as claimed in claim 1, wherein the layer consists of three materials, in particular of three carbides.

6. The incandescent lamp as claimed in claim 1, wherein the luminous element uses TaC as carrier material.

7. The incandescent lamp as claimed in claim 1, wherein the coating uses at least the materials tantalum carbide and hafnium carbide.

8. The incandescent lamp as claimed in claim 1, wherein the coating uses at least the materials tantalum carbide and zirconium carbide.

9. The incandescent lamp as claimed in claim 1, wherein the carrier material and one of the materials of the coating are identical.

10. The incandescent lamp as claimed in claim 1, wherein use is made as carrier material of tantalum carbide that is firstly coated with hafnium carbide or zirconium carbide and then tantalum carbide.

11. A method for producing a luminous element for an incandescent lamp as claimed in claim 1, wherein in a first step initially at least two different metals, in particular selected from the group of Ta, Hf, Ar, are deposited one after another or simultaneously on the carrier material of the luminous element, and subsequently a carburization or nitriding or boration of these metals is undertaken.

12. A method for producing a luminous element for an incandescent lamp as claimed in claim 1, wherein at least two compounds from the group of the metal carbides, metal nitrides or metal borides are deposited one after another or simultaneously in the form of these compounds on the luminous element.

13. The method as claimed in claim 11, wherein subsequently a diffusive mixing of carrier material and coating materials is performed by the influence of heat such that alloying occurs between the carrier material and the material of the coating, at least on the surface of the carrier material that adjoins the coating.

14. The method as claimed in claim 11, wherein an intermediate step in which the deposited metals mix diffusively with the carrier material under the influence of heat is performed between the first and the second step.

15. The method as claimed in claim 11, wherein the coating is performed by CVD processes, PVD processes, electrolytic deposition, wet chemical methods or flushing methods.

16. The method as claimed in claim 12, wherein subsequently a diffusive mixing of carrier material and coating materials is performed by the influence of heat such that alloying occurs between the carrier material and the material of the coating, at least on the surface of the carrier material that adjoins the coating.

17. The method as claimed in claim 12, wherein the coating is performed by CVD processes, PVD processes, electrolytic deposition, wet chemical methods or flushing methods.

18. The method as claimed in claim 13, wherein the coating is performed by CVD processes, PVD processes, electrolytic deposition, wet chemical methods or flushing methods.

19. The method as claimed in claim 14, wherein the coating is performed by CVD processes, PVD processes, electrolytic deposition, wet chemical methods or flushing methods.
